(19) United States
(12) Patent Application Publication
(10) Pub. No.: US 2007/0184851 A1
(43) Pub. Date: Aug. 9, 2007

(54) Methods and apparatus for location synthesis in a wireless network environment

(75) Inventors: Richard Barnwell, Bolton, MA (US); R. Sean Lindsay, Newton, MA (US)

Correspondence Address: WOLF GREENFIELD & SACKS, P.C., 600 ATLANTIC AVENUE, BOSTON, MA, 02210-2206, US

(73) Assignee: PanGo Networks, Inc., Framingham, MA (US)

(21) Appl. No.: 11/648,379

(22) Filed: Dec. 29, 2006

Related U.S. Application Data
(60) Provisional application No. 60/755,375, filed on Dec. 30, 2005.

(51) Int. Cl. H04Q 7/20

(52) U.S. Cl. 455/456.1

(57) ABSTRACT

In one aspect, a software application for location determination of a mobile device connected to at least one network is provided. The software application comprises a first input to receive first location information indicative of a first possible location of the mobile device, the first location information obtained from a first source and determined based, at least in part, on signals exchanged over a first wireless connection of the at least one network, a second input to receive second location information indicative of a second possible location of the mobile device, the second location information obtained from a second source and determined based, at least in part, on signals exchanged over a second connection of the at least one network, and a location synthesizer coupled to the first input and the second input, the location synthesizer adapted to determine a synthesized location of the mobile device based, at least in part, on the first location information and the second location information.

### RELATED APPLICATION

This application claims priority under 35 U.S.C. §119(e) to U.S. Provisional Application Ser. No. 60/755,375, entitled “METHODS AND APPARATUS FOR LOCATION SYNTHESIS IN A WIRELESS NETWORK ENVIRONMENT,” filed on Dec. 30, 2005, which is herein incorporated by reference in its entirety.

### FIELD OF INVENTION

The present invention relates to location-aware networks, and more particularly, to location determination of a mobile device in a network environment.

### BACKGROUND OF INVENTION

Aspects of many enterprise operations may benefit from an ability to determine the location of objects of interest within a specified area or region. Examples include, but are not limited to, tracking inventory, locating assets or personnel, providing location specific content or media, etc. The proliferation of wireless local area networks (LAN) has enabled many enterprises, such as corporations, businesses and other organizations to capitalize on location tracking technology. In particular, an enterprise's existing wireless LAN infrastructure may be used to implement systems for locating, tracking and/or monitoring assets in a wireless LAN environment.

The term “asset” refers herein to any object whose location may be of interest, including, but not limited to, articles of manufacture, wholesale or retail inventory, medical devices, manufacturing equipment, information technology (IT) equipment, containers, personnel or any other object for which location tracking and/or monitoring may be desirable. In some instances, the asset itself may be network-aware, that is, the asset itself may be adapted to communicate with a wireless network. Examples of network aware assets may include laptop computers, cellular telephones, personal digital assistants (PDA's), hand held devices, etc. In some instances, the asset for which tracking is desired may not itself be network-aware. For example, a variety of articles of manufacture, inventory, human personnel, etc., may have limited or no ability to communicate with a network.

To enable location determination of such assets (i.e., to make the assets network-aware), a radio frequency identification (RFID) tag may be affixed to the asset to relay location information about the asset to the network. For example, an enterprise having a large and generally mobile inventory of objects may affix an RFID tag to desired objects to keep track of where particular inventory is currently located. Hospitals, for instance, often have extensive equipment that may be moved from place to place to service patients in different rooms, departments, etc. It may be important to know where such equipment is located to respond to emergencies or otherwise effectively service patients and efficiently provide staff with the necessary equipment. RFID tags may also be affixed to personnel to track the location of, for example, security personnel, doctors, nursing staff or other employees of an enterprise who may need to be located.

In general, network-aware assets communicate with access points (or specialized sensors) distributed in a wireless network environment. Characteristics of the communication are analyzed to determine the location of the asset. Many techniques are available for determining location. For example, the time delay of arrival (TDOA), time of arrival (TOA), or the angle of arrival (AOA) of a communication from the asset at each of the access points within range may be used to determine the location of the asset. In addition, obtaining radio signal strength indicators (RSSI), often referred to as RF fingerprinting, may be used to determine the location of the asset. In particular, the signal strength of the transmission from the asset at the various access points may be used to determine the location of the asset within the network environment.

### SUMMARY OF THE INVENTION

Some embodiments of the present invention include a method of determining a location of a mobile device in a networked environment having at least one network to which the mobile device is capable of connecting, the method comprising receiving first location information indicating a first possible location of the mobile device, the first location information determined based, at least in part, on signals exchanged between the mobile device and the at least one network over a first wireless connection, receiving second location information indicating a second possible location of the mobile device, the second location information determined based, at least in part, on signals exchanged between the mobile device and the at least one network over a second connection, and determining a synthesized location of the mobile device based, at least in part, on the first location information and the second location information.

Some embodiments of the present invention include an apparatus for location determination of a mobile device in a networked environment, the networked environment including at least one network, the apparatus comprising at least one first component connected to the network, the at least one first component adapted to provide first location information indicative of a first possible location of the mobile device, the first location information determined based, at least in part, on signals exchanged between the mobile device and the at least one network over a first wireless connection, at least one second component connected to 10 the network, the at least one second component adapted to provide second location information indicative of a second possible location of the mobile device, the second location information based, at least in part, on signals exchanged between the mobile device and the at least one network over a second connection, and at least one location synthesizer connected to the network, the at least one location synthesizer adapted to receive the first location information from the at least one first component and the second location information from the at least one second component, and to determine a synthesized location of the mobile device based, at least in part, on the first location information and the second location information.

Some embodiments of the present invention include a software application for location determination of a mobile device connected to at least one network, the software application comprising a first input to receive first location information indicative of a first possible location of the mobile device, the first location information obtained from a first source and determined based, at least in part, on signals exchanged over a first wireless connection of the at least one network, a second input to receive second location information indicative of a second possible location of the mobile device, the second location information obtained from a second source and determined based, at least in part, on signals exchanged over a second connection of the at least one network, and a location synthesizer coupled to the first input and the second input, the location synthesizer adapted to determine a synthesized location of the mobile device based, at least in part, on the first location information and the second location information.

### BRIEF DESCRIPTION OF DRAWINGS

FIG. 1 illustrates a location-aware wireless local area network (LAN) servicing a plurality of network clients, in accordance with some embodiments of the invention;

FIG. 2 illustrates a software application integrating location information from a wireless local area network (LAN) and a wide area network (WAN) to synthesize a location of an asset, in accordance with some embodiments of the invention;

FIG. 3 illustrates a software application integrating location information from a wireless local area network (LAN) and an radio frequency identification (RFID) network to synthesize a location of an asset, in accordance with some embodiments of the invention;

FIG. 4 illustrates a software application integrating location information from a wireless local area network (LAN) and a wired network to synthesize a location of an asset, in accordance with some embodiments of the invention; and

FIG. 5 illustrates a software application integrating location information from a wireless local area network (LAN), a WAN, an RFID network, and a wired network to synthesize a location of an asset, in accordance with some embodiments of the invention.

### DETAILED DESCRIPTION

As discussed above, a location-aware network may benefit a wide variety of asset tracking applications, various location-based content distribution services, etc. Wireless LAN technology has provided a convenient infrastructure for implementing location-awareness. However, location information may be generated from other sources as well. The increased interest and utility of location determination and tracking has given rise to numerous sources of location information. For example, global positioning satellites (GPS) and cellular technology can provide geographical information about a mobile device or asset over wide area networks (WAN). In addition, radio frequency identification (RFID) systems can locate RFID tags by detecting when a tag is located proximate to one or more RFID sensors or readers.

However, the various sources of location information may have certain limitations. For example, GPS signals are generally unavailable indoors rendering the technology of little use inside buildings, warehouses, etc. Cellular technologies may be limited in the precision by which cellular devices may be located. In particular, cellular technologies may be limited to determining which cell the device is located within. Other cellular technologies have improved the scale to which cellular devices may be located, but still may be generally limited in accuracy. RFID technologies may only be useful when an RFID tag comes within relatively close proximity to an RFID sensor and/or reader, making RFID technologies less useful as a general purpose locator.

Applicant has appreciated that the accuracy and/or availability of location determination may be improved by integrating location information from a plurality of sources, a process referred to herein as “location synthesis.” By integrating multiple technologies, the strengths of the various technologies may be utilized together to provide a more robust and accurate location determination system. In one embodiment, location information obtained from a first source and location information obtained from a second source are integrated to form a synthesized location of a mobile device or asset.

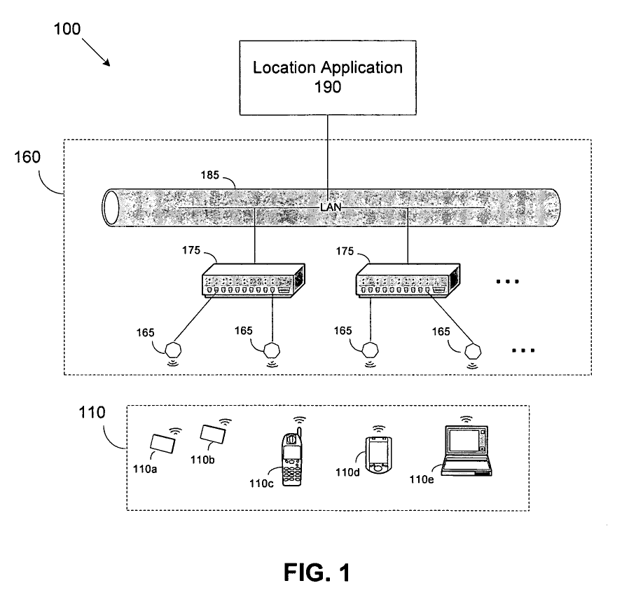

As mentioned above, location information may be obtained from a wireless local area network (LAN). FIG. 1 illustrates an exemplary location-aware wireless LAN, in accordance with some embodiments of the present invention. Wireless LAN 100 includes a number of mobile devices 110. For example, wireless LAN 100 may service mobile devices including any one or combination of RFID tags 110a and 110b, cellular telephone 110c, PDA 110d, and laptop computer 110e. The wireless LAN includes network infrastructure 160 having a plurality of access points 165 to relay wireless signals to network switches 175, which in turn direct information over the physical LAN connections 185.

Also coupled to the LAN may be one or more location applications 190 that determine the location of one or more network clients and/or performs various location determination tasks. For example, location application 190 may include an asset tracking application that employs location information to display the location of network clients on a user interface, such as displaying an icon of the various clients on a plan or map of the space or area that the wireless LAN services. Location application 190 may be a software component operating on one or more network servers, or other network device configured to execute the location application. Location application 190 may be connected to other networks in addition to wireless LAN 100, as discussed in further detail below.

There are several general modes in which a location-aware wireless network may operate. In a first mode, the network infrastructure may implement, to varying extents, some portion of the location determination capabilities. In this mode, the access points operate as readers, receiving transmissions from the clients from which location information is extracted. In some instances, location application 190 may be provided by the network infrastructure vendor and may include functionality to extract location information and/or determine location from the signals received at the access points. The access points themselves may include some level of location-awareness. For example, the access points may compute one or more measurements (e.g., RSSI, TDOA, TOA, AOA, etc.) of received transmissions and relay this location information to other resources to determine the location of the respective mobile device. It should be appreciated that the manner in which the network implements location-awareness is not a limitation on the various aspects of the invention.

In a second mode, the network infrastructure may not implement any or may implement very limited location determination functionality. For example, network access points may be ignorant of location enabled devices and/or are incapable of acting as readers with respect to location determination. In such a network environment, mobile devices (e.g., a cellular phone, laptop, an RFID tag, etc.) may operate as readers, receiving transmissions from the access points from which location information is extracted. For example, one or more of the network clients may perform RSSI measurements on transmissions received from various access points that are within range. The mobile device may then transmit this location information to, for example, location application 190 via standard communications with the wireless LAN.

The IEEE 802.11 standard has gained industry acceptance and relatively widespread implementation and use in wireless LANs. The term 802.11 network refers generically to any network conforming to and/or interoperable with the IEEE 802.11 standard for wireless LAN technology, including versions 802.11b and 802.11g and its progeny, and version 802.11a for accelerated communications. Present versions and new versions to be released in the future are designed to be backwards compatible, and therefore all versions will be referred to generically as 802.11 to indicate compatibility with the standard in general. Any device capable of communicating in accordance with at least one version, for example, the 802.11b/g family and its progeny, may be considered 802.11 compatible. The term Wireless Fidelity (Wi-Fi®) refers to 802.11 networks and/or devices that have been certified as 802.11 compliant according to interoperability tests performed by the Wi-Fi Alliance.

Accordingly, 802.11 networks have been widely used to implement location-aware networks. Location determination in a wireless LAN environment is discussed in U.S. patent application Ser. No. 11/606,409 (the '409 application), entitled “METHOD AND APPARATUS FOR AN ACTIVE RADIO FREQUENCY IDENTIFICATION TAG,” which is herein incorporated by reference in its entirety. As discussed above, other location determination technologies are available to locate, track and/or monitor generally mobile network devices. Applicant has appreciated that other sources of location information may be used to supplement wireless LAN location determination to improve the accuracy and/or availability of location determination.

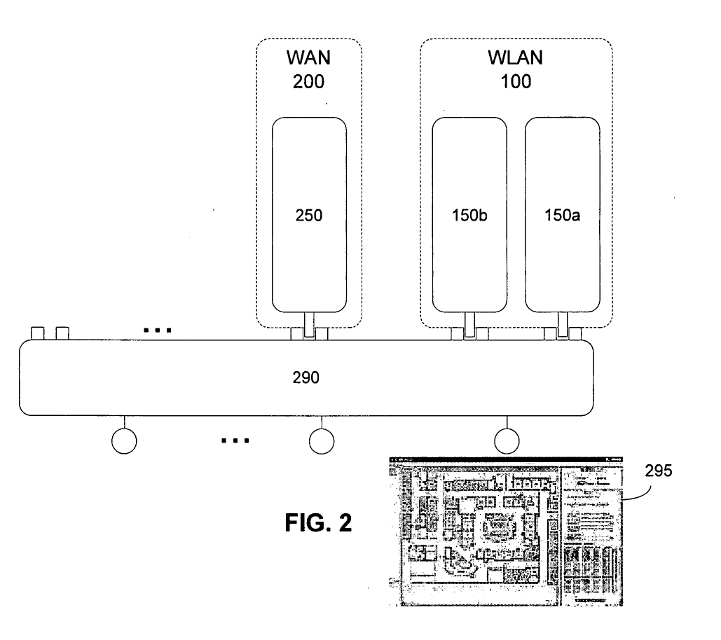

FIG. 2 illustrates a system adapted to integrate location information from a plurality of sources for location synthesis, in accordance with some embodiments of the present invention. Software application 290 may be one or more software programs connected to one or more networks, and configured to obtain location information via a plurality of providers. A provider may be a software and/or hardware adapter configured to obtain location information via an associated network connection. Providers may be software components or modules of application 290, or may be separate software components operating on one or more servers or devices connected to application 290 via one or more networks. In FIG. 2, software application 290 receives location information from wireless LAN providers 150a and 150b and wide area network (WAN) provider 250.

Providers 150 and 250 obtain location information from wireless LAN 100 and WAN 200, respectively. In particular, providers 150a and 150b may obtain location information from an 802.11 network according to the first mode and second mode, respectively, as described above in connection with FIG. 1. For example, provider 150a may be configured to receive signals from mobile devices connected to the wireless LAN and compute a location of the devices based on the signals. That is, provider 150a may be one or more components that form a location-aware network infrastructure. As such, provider 150a may include access points of the wireless LAN, one or more servers or other network infrastructure adapted to determine the location of mobile devices connected to the wireless LAN via signals exchanged between the mobile devices and the wireless LAN. Provider 150a may determine location information using any of various wireless LAN technologies such as TOA, TDOA, AOA and/or RSSI measurements of transmitted signals from mobile devices connected to the network.

Provider 150b may be configured to receive location information directly from mobile devices that themselves are location-aware. For example, provider 150b may be configured to obtain location information from one or more active RFIDs, laptops, handheld devices, cellular phones, etc. that have been adapted to determine location information based on signals received from the wireless LAN according to one or more wireless LAN location technologies (e.g., TOA, TDOA, AOA and/or RSSI). Provider 150a and 150b may be integrated into a single provider or may be separate providers. It should be appreciated that both providers need not be present, as the aspects of the invention are not limited in this respect. For example, there may be a single provider 150 adapted to provide location information of mobile devices based on the mobile devices wireless connection.

Provider 250 may be configured to obtain location information about a mobile device from a WAN, for example, a cellular WAN, a GPS network, etc., and provide the location information to software application 290. As with provider 150, provider 250 may be a component of application 290 or a separate server or device connected to the WAN and coupled to application 290 via one or more networks (e.g., the wireless LAN, WAN, etc.) As a result, software application 290 may receive location information about a mobile device from multiple sources (e.g., from the wireless LAN via provider 150 and from the WAN via provider 250). Software application 290 may then synthesize a location for the mobile device based on the wireless LAN and WAN location information, as discussed in further detail below.

Software application 290 may be connected to any of various interface applications, such as interface application 295 that presents location information about various mobile devices or assets to users. For example, interface application 295 may present a map or plan of the area serviced by wireless LAN 100, WAN 200 or some combination of both and display an icon denoting the location of any assets being tracked by software application 290. Any other application, inventory monitoring service, web-based application, etc., may be coupled to software application 190 to provide location information in any desired form or format, as the aspects of the invention are not limited in this respect.

In some embodiments according to the present invention, software application 290 integrates wireless LAN and WAN location information to synthesize the location of a cellular device, such as a cellular telephone. For example, cellular telephone 110c illustrated in FIG. 1 may be a dual-mode mobile telephone. In particular, cellular telephone 110c may include a cellular wide area network (WAN) transceiver and an 802.11 (e.g., Wi-Fi) transceiver, such that the cellular phone may communicate via networks of either type (e.g., wireless LAN 100 and/or WAN 200). When communicating with the cellular WAN, the cellular phone may be located using various techniques such as assisted global positioning system (A-GPS), base station triangulation, etc., using, for example, the cellular phone's cellular identification (e.g., subscriber identity module (SIM) number). When communicating with the 802.11 network (or other wireless LAN standard), the cellular phone may be located using one or more 802.11 location determination techniques (e.g., RSSI, TDOA, TOA, AOA, etc.), using, for example, the cellular phone's MAC address.

A-GPS typically utilizes one or more assistance servers (e.g., mobile location servers) coupled to a cellular network. A cellular device may receive GPS signals and transmit the signals to the assistance server which then computes the location of the cellular device. Provider 250 may be adapted to communicate with either the cellular device, the assistance server or both to obtain location information about the cellular device. Alternatively, other cellular location determination technologies such as triangulation, implicit location based on proximity to a base station, etc., may be used to generate location information about the cellular device, either in the absence of, or in combination with A-GPS. Provider 250 may be configured to communicate with base stations that are adapted to perform such location determinations, or provider 250 may be configured to perform the location determination itself.

The cellular device may therefore be tracked using multiple technologies. It may be desirable to integrate location information from the multiple technologies to seamlessly track the cellular device and/or to obtain more accurate information about the location of the cellular device. For example, when the cellular device is operated outdoors, A-GPS, GPS and/or base station triangulation may be used to track the cellular phone. That is, provider 250 obtains location information about the cellular device from the WAN and provides the information to application 290.

When the cellular device is carried indoors (or is transported within range of an 802.11 network), the cellular phone may be tracked using 802.11 technology, either to exploit the increased accuracy of the Wi-Fi location technologies or because one or more of the WAN techniques becomes unavailable (e.g., GPS techniques are generally unavailable indoors). In particular, providers 150a and/or 150b obtain location information about the cellular device via the wireless LAN (e.g., obtain location information about the cellular device from the 802.11 network) and provide the location information to software application 290. To seamlessly track the cellular device, it may be advantageous to switch between the two technologies as deemed appropriate. For example, location application 290 may switch from using location information provided by provider 250 (e.g., using a WAN-based technology) to location information provided by provider 150a and/or 150b (e.g., using a wireless LAN based technology) as the cellular device is transported from outdoors to indoors, or vice versa.

In certain situations, application 290 may be receiving location information from both sources (i.e., from both providers 250 and 150a/150b). Application 290 may integrate the location information from the multiple sources to provide accurate tracking of the cellular device. For example, application 290 may use an average of the locations provided by the WAN and wireless LAN networks. Alternatively, application 290 may filter out the location information from the least appropriate of the two sources. In one embodiment, application 290 uses a weighted average that changes over time such that one of the sources is filtered out (e.g., receives a zero weight) as the cellular phone transitions from locations more suitable to one technology to locations more suitable to the other technology. Other information such as historical past observation or a priori knowledge may be used to decide how to best integrate the location information obtained from the multiple sources, as the invention is not limited in this respect. It should be appreciated that integrating WAN and wireless LAN location information may be applied to any mobile device and is not limited for use with cellular devices.

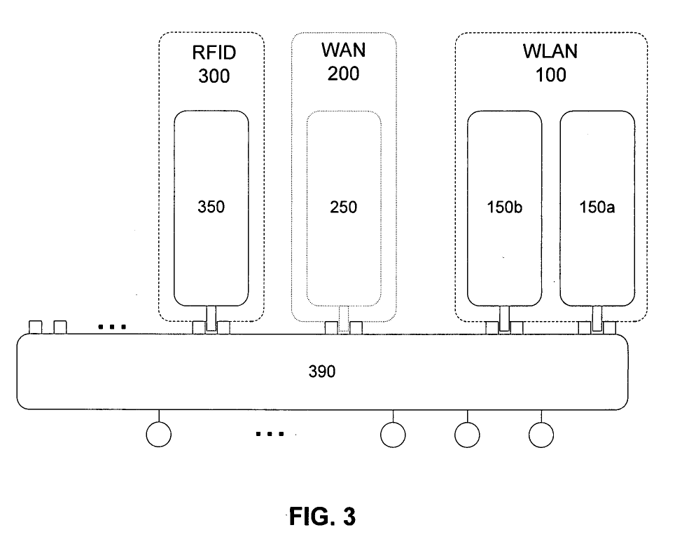

FIG. 3 illustrates a software platform adapted to integrate location information from a plurality of sources for location synthesis, in accordance with some embodiments of the present invention. Software application 390 may be similar to software application 290, except software application 390 is coupled to RFID provider 350 adapted to obtain location information from RFID network 300. WAN provider 250 is shown in phantom lines to indicate that some embodiments may include WAN provider 250 and other embodiments may not. Location information obtained by RFID provider 350 may be integrated with wireless LAN location information to synthesize the location of an asset.

RFID tags have been used in a variety of applications, including, but not limited to, security, asset tracking, identification, etc. For example, many identification cards include RFIDs that transmit a signal that may be detected and registered by an RFID reader, for example, at a security checkpoint, inventory monitoring station, etc. RFID tags may be affixed to assets such that when the asset passes by an RFID reader, its location may be inferred from the known location of the reader. As a result, the fact that the asset was transported into or out of a particular region monitored by the RFID reader can be catalogued and tracked. RFID network 300 may include any number of RFID readers and RFID tags. Location information from the RFID readers may be accessed and obtained by RFID provider 350 and provided to software application 390 for location synthesis.

Conventional RFID devices transmit a signal that can be detected by an RFID reader, but are typically not network aware. That is, conventional RFID devices do not connect to and exchange information with a network, or may not be capable of receiving network communications. Such conventional RFID devices (also referred to as tags) are referred to herein as “passive.” As discussed in the '409 application, an active RFID tag may operate in a similar fashion to a passive RFID tag, but may also include network capabilities. For example, an active RFID tag may be capable of communicating over a wireless LAN (e.g., communicating according to the 802.11 protocol) and/or may be adapted to determine location information about itself via wireless LAN signals.

In some embodiments, location information obtained from one or more passive RFID readers connected via an RFID network is integrated with location information determined using 802.11 wireless techniques to synthesize the location of the RFID device. For example, application 390 may receive location information from provider 350 accessing information obtained by the one or more RFID readers, and provider 150a and/or provider 150b obtain location information via the wireless LAN (e.g., from a passive and active RFID tag, respectively, or an RFID tag that has active and passive components associated with an asset). When the RFID tag passes by an RFID reader, provider 350 may access the RFID network to obtain this location information and provide it to software application 390, which may infer the location of the tag from the location of the RFID reader that detected the signal from the RFID tag. Otherwise, software application 390 may use location information determined from wireless LAN characteristics obtained by providers 150a and/or 150b to determine the location of the tag. The RFID network may be any type of network communicating under any protocol, as the aspects of the invention are not limited in this respect.

Software application 390 may give preference and/or precedence to the different location indicators depending on a defined set of rules. As discussed above, the location of the asset may be determined using a pure or weighted average of the location of the mobile device (e.g., an RFID tag) derived from location information obtained from the different sources. Alternatively, the passive RFID location information may be used to correct or adjust the active RFID location information (e.g., WLAN location information) or may be given precedence and used in place of the active RFID location information.

In some circumstances, the passive RFID location information can be used to dampen jitter that sometimes effects location determination using 802.11 techniques. For example, location of an asset determined using 802.11 techniques (e.g., RSSI, TDOA, TOA, AOA, etc.) often have a radius of error within which the precise location of an asset cannot be precisely determined. This radius of error for RSSI techniques, for example, may be up to several meters. Accordingly, due to natural variation in 802.11 signals (e.g., RF fluctuations), the location determined for an asset may change slightly on each computation when the asset is in fact stationary.

An often irksome situation arises when an asset is located near a boundary between rooms and the asset's location is alternately determined to be in one room then the other. Passive RFID location information may be used to dampen this so-called jitter. In particular, when an asset is close enough to an RFID reader to be sensed, this information can be used to infer that the asset is substantially stationary rather than moving in location, for example, in and out of rooms or doorways, or toggling between one side of the RFID reader and the other.

In other embodiments, the location of an asset may be inferred from the location of a mobile RFID reader. For example, bar code readers and other mobile RFID readers used to scan inventory are often connected wirelessly to a network, for example, to update an inventory database connected to the network. The mobile RFID reader may itself be locatable using 802.11 location determination techniques (or other location determination techniques). Accordingly, when the mobile RFID reader scans an RFID tag, the location of the RFID tag can be inferred from the location of the RFID reader. It should be appreciated that location information obtained from an RFID network and a wireless LAN may be integrated in other ways, as the aspects of the invention are not limited in this respect.

In some embodiments, location information about a mobile device may be obtained from a wireless LAN, a WAN and an RFID network. For example, the mobile device may have 802.11, cellular (or GPS or A-GPS) and RFID capabilities. In these circumstances, providers 150, 250 and 350 may, at times, be providing location information about the mobile device to application 390. In response, application 390 may synthesize a location of the mobile device based on the multiple location information received from the different sources. As discussed above, application 390 may include rules that combine the location information in any way, or that describe circumstances in which location information from one or more providers should take precedence over location information received from other providers.

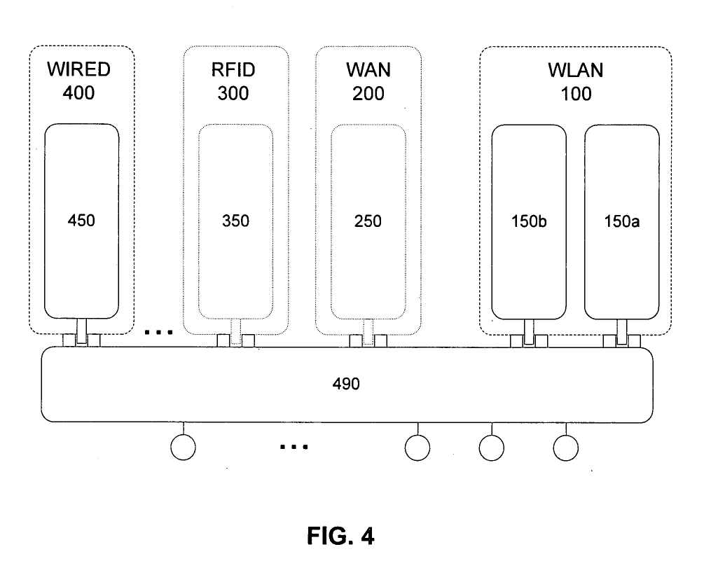

FIG. 4 illustrates a software platform adapted to integrate location information from a plurality of sources for location synthesis, in accordance with some embodiments of the present invention. Software application 490 may be similar to software application 290 and/or 390, except software application 490 may also (or in place of) be connected to wired provider 450 adapted to obtain location information from wired network 400. Wired network may include one or more devices connected via hardwiring, such as an Ethernet local area network. In some embodiments, wired network 400 may be the wired portion of wireless LAN 100 to which the access points are connected. Typically, the location of the data ports in a wired network are generally known. That is, each port may be catalogued in a database maintained by the network administrator. This information may be used to determine the location of assets.

For example, laptop computer 110e illustrated in FIG. 1 may include a network card adapted for wireless connectivity (e.g., 802.11 connectivity) and any of the various standard network ports (e.g., an Ethernet port) for connecting to a LAN, WAN or both. Laptop computer 110e may be a laptop used in a typical work environment where access to the network occurs both wirelessly and via wired data ports. For example, the laptop may be connected to one of multiple wired network ports via an Ethernet connection to access the network (e.g., via a docking station located in an office). In addition, the laptop may connect to the network via the wireless connection, for example, during a meeting in a conference room or in other circumstances and/or locations where a wired port is not available and/or it is desirable to use the wireless connection.

When the laptop is connected via a wired data port, its location can be inferred from the location of the network data port. That is, provider 450 may detect that the laptop is connected to a particular port and access the database to determine where the port is located and provide the location information to software application 490. When the laptop is disconnected from the data port, for example, when the laptop is carried from an office docking station to a conference room, and the wireless port is used to access the network, the location of the laptop may be determined using one or more wireless techniques (e.g., RSSI, TDOA, TOA, AOA, etc.).

Location information from both the wired and wireless ports may be integrated to synthesize a location for the laptop. In addition, location information obtained via the wired port may be used to improve the wireless location determination, for example, as prior or additional information to aid in localizing and improving the wireless location determination (e.g., used to dampen jitter). Location information from wired and wireless ports may be used and/or integrated in other ways to synthesize location, as the aspects of the invention are not limited in this respect.

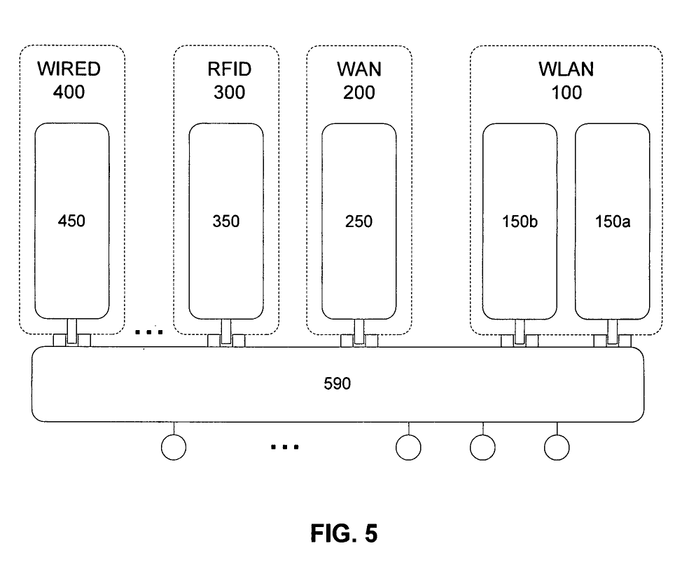

FIG. 5 illustrates a software platform adapted to integrate location information from a plurality of sources for location synthesis, in accordance with some embodiments of the present invention. Software application 590 includes all the providers described in connection with FIGS. 2-4, which provide location information from respective networks to software application 590 to synthesize location of various assets being tracked. Accordingly, software application 590 may include a defined set of rules describing how location information from the plurality of sources should be integrated to form a synthesized location. Any integration, precedence and/or preference rules may be defined, as the aspects of the invention are not limited in this respect.

It should be appreciated that any combination of sources may be used to synthesize location information, as the aspects of the invention are not limited in this respect. For example, any of the above described providers (or providers adapted to obtain location information from other sources) in any combination may be used to obtain location information which can be synthesized into a location of the asset. There are no requirements as to which providers are used and/or made available.

As should be appreciated from the foregoing, there are numerous aspects of the present invention described herein that can be used independently of one another or in any combination, including the aspects that relate to which providers are used and/or made available. It should also be appreciated that in some embodiments, all of the above-described providers can be used together, or any combination or subset of the providers described above can be employed together in a particular implementation, as the aspects of the present invention are not limited in this respect. In addition, the various aspects of the invention may be applied to any mobile device and is not limited for use with any particular device and/or network-aware asset.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code. In this respect, it should be appreciated that one embodiment of the invention is directed to a computer-readable medium or multiple computer-readable media (e.g., a computer memory, one or more floppy disks, compact disks, optical disks, magnetic tapes, etc.) encoded with one or more programs that, when executed, on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that, when executed, perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing, and the aspects of the present invention described herein are not limited in their application to the details and arrangements of components set forth in the foregoing description or illustrated in the drawings. For example, the various sources from which location information is provided may be implemented in any combination, and is not limited to the combinations discussed in the embodiments described in the foregoing. The aspects of the invention are capable of other embodiments and of being practiced or of being carried out in various ways.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A method of determining a location of a mobile device in a networked environment having at least one network to which the mobile device is capable of connecting, the method comprising:
receiving first location information indicating a first possible location of the mobile device, the first location information determined based, at least in part, on signals exchanged between the mobile device and the at least one network over a first wireless connection;
receiving second location information indicating a second possible location of the mobile device, the second location information determined based, at least in part, on signals exchanged between the mobile device and the at least one network over a second connection; and
determining a synthesized location of the mobile device based, at least in part, on the first location information and the second location information.

2. The method of claim 1, wherein the at least one network includes a local area network (LAN), and wherein first wireless connection is an 802.11 connection to the (LAN).

3. The method of claim 2, wherein the second connection is a wired connection between the mobile device and the LAN, and wherein the second location information is based on a known location of a network port at which the wired connection is made.

4. The method of claim 3, wherein determining a synthesized location of the mobile device includes modifying the first location information based on the second location information.

5. The method of claim 3, further comprising determining whether the mobile device is connected to the LAN via the wired connection, and wherein determining the synthesized location includes determining the synthesized location based on the first location information when it is determined that the mobile device is not connected to the LAN via the wired connection, and determining the synthesized location based on the second location when it is determined that the mobile device is connected to the LAN via the wired connection.

6. The method of claim 2, wherein the at least one network connection includes a wide area network (WAN), and wherein the second connection is a second wireless connection to the WAN.

7. The method of claim 6, wherein the mobile device is a cellular device, and the WAN includes a cellular network.

8. The method of claim 7, wherein the second location information is determined using assisted global positioning satellite (A-GPS) technology.

9. The method of claim 7, wherein determining the synthesized location includes performing a weighted average of the first location information and the second location information.

10. The method of claim 7, wherein the LAN services an indoor space, and the WAN services an outdoor space, and wherein determining the synthesized location includes using the first location information when the mobile device is located in the indoor space and using the second location information when the mobile device is located in the outdoor space.

11. The method of claim 6, wherein the mobile device includes a global positioning satellite (GPS) receiver, and the WAN includes a GPS network.

12. The method of claim 11, wherein the second location information is based, at least in part on GPS signals.

13. The method of claim 2, wherein the at least one network includes a radio frequency identification (RFID) network having at least one RFID reader, and wherein the mobile device is an RFID device.

14. The method of claim 13, wherein the second connection includes RFID signals transmitted from the RFID device and detected by at least one RFID reader, and wherein the second location information is based on a known location of the at least one RFID reader.

15. The method of claim 14, determining a synthesized location of the mobile device includes using the second location information to stabilize the first location information.

16. An apparatus for location determination of a mobile device in a networked environment, the networked environment including at least one network, the apparatus comprising:
at least one first component connected to the network, the at least one first component adapted to provide first location information indicative of a first possible location of the mobile device, the first location information determined based, at least in part, on signals exchanged between the mobile device and the at least one network over a first wireless connection;
at least one second component connected to the network, the at least one second component adapted to provide second location information indicative of a second possible location of the mobile device, the second location information based, at least in part, on signals exchanged between the mobile device and the at least one network over a second connection; and
at least one location synthesizer connected to the network, the at least one location synthesizer adapted to receive the first location information from the at least one first component and the second location information from the at least one second component, and to determine a synthesized location of the mobile device based, at least in part, on the first location information and the second location information.

17. The apparatus of claim 16, wherein the at least one network includes a local area network (LAN), and wherein the first wireless connection includes an 802.11 connection to the LAN.

18. The apparatus of claim 17, wherein the first location information is based, at least in part, on at least one wireless technology from a group consisting of:
at least one radio signal strength indicator (RSSI) measurement;
at least one time delay of arrival (TDOA) measurement;
at least one time of arrival (TOA) measurement; and
at least one angle of arrival (AOA) measurement.

19. The apparatus of claim 17, wherein the second connection is a wired connection between the mobile device and the LAN, and wherein the second component determines the second location information based on a known location of a network port at which the wired connection is made.

20. The apparatus of claim 19, wherein the location synthesizer is configured to modify the first location information based on the second location information.

21. The apparatus of claim 19, wherein the second component determines whether the mobile device is connected to the LAN via the wired connection, and wherein the location synthesizer is configured to determine the synthesized location based on the first location information when it is determined that the mobile device is not connected to the LAN via the wired connection, and to determine the synthesized location based on the second location when it is determined that the mobile device is connected to the LAN via the wired connection.

22. The apparatus of claim 17, wherein the at least one network includes a wide area network (WAN), and wherein the second connection is a second wireless connection to the WAN.

23. The apparatus of claim 22, wherein the mobile device is a cellular device, and the WAN includes a cellular network.

24. The apparatus of claim 23, wherein the second component is configured to determine the second location information using at least one technology from a group consisting of:
assisted global positioning satellite (A-GPS) technology; and
base station triangulation.

25. The apparatus of claim 22, wherein the location synthesizer is configured to determine the synthesized location, at least in part, by performing a weighted average of the first location information and the second location information.

26. The apparatus of claim 22, wherein the LAN services an indoor space, and the WAN services an outdoor space, and wherein the location synthesizer is configured to determine the synthesized location using the first location information when the mobile device is located in the indoor space and using the second location information when the mobile device is located in the outdoor space.

27. The apparatus of claim 22, wherein the mobile device includes a global positioning satellite (GPS) receiver, and the WAN includes a GPS network.

28. The apparatus of claim 27, wherein the second location information is based, at least in part on GPS signals received at the GPS receiver.

29. The apparatus of claim 17, wherein the at least one network includes a radio frequency identification (RFID) network having at least one RFID reader, and wherein the mobile device is an RFID device.

30. The apparatus of claim 29, wherein the second connection includes RFID signals transmitted from the RFID device and detected by at least one RFID reader, and wherein the second component determines the second location information based on a known location of the at least one RFID reader.

31. The apparatus of claim 30, wherein the location synthesizer is configured to use the second location information to stabilize the first location information.

32. A software application for location determination of a mobile device connected to at least one network, the software application comprising:
a first input to receive first location information indicative of a first possible location of the mobile device, the first location information obtained from a first source and determined based, at least in part, on signals exchanged over a first wireless connection of the at least one network;
a second input to receive second location information indicative of a second possible location of the mobile device, the second location information obtained from a second source and determined based, at least in part, on signals exchanged over a second connection of the at least one network; and
a location synthesizer coupled to the first input and the second input, the location synthesizer adapted to determine a synthesized location of the mobile device based, at least in part, on the first location information and the second location information.

33. The software application of claim 32, wherein the at least one network includes a local area network (LAN), and wherein the first wireless connection is an 802.11 connection to the LAN.

34. The software application of claim 33, wherein the first location information is determined based, at least in part, on at least one wireless technology from a group consisting of:
at least one radio signal strength indicator (RSSI) measurement;
at least one time delay of arrival (TDOA) measurement;
at least one time of arrival (TOA) measurement; and
at least one angle of arrival (AOA) measurement.

35. The software application of claim 33, wherein the second connection is a wired connection between the mobile device and the LAN, and wherein the second location information is determined based on a known location of a network port at which the wired connection is made.

36. The software application of claim 35, wherein the location synthesizer is configured to modify the first location information based on the second location information.

37. The software application of claim 35, wherein the location synthesizer is configured to determine the synthesized location based on the first location information when it is determined that the mobile device is not connected to the LAN via the wired connection, and to determine the synthesized location based on the second location when it is determined that the mobile device is connected to the LAN via the wired connection.

38. The software application of claim 33, wherein the at least one network includes a wide area network (WAN), and wherein the second connection is a second wireless connection to the WAN.

39. The software application of claim 38, wherein the mobile device is a cellular device, and the WAN includes a cellular network.

40. The software application of claim 39, wherein second location information is determined using at least one technology from a group consisting of:
assisted global positioning satellite (A-GPS) technology; and
base station triangulation.

41. The software application of claim 38, wherein the location synthesizer is configured to determine the synthesized location, at least in part, by performing a weighted average of the first location information and the second location information.

42. The software application of claim 38, wherein the LAN services an indoor space, and the WAN services an outdoor space, and wherein the location synthesizer is configured to determine the synthesized location using the first location information when the mobile device is located in the indoor space and using the second location information when the mobile device is located in the outdoor space.

43. The software application of claim 38, wherein the mobile device includes a global positioning satellite (GPS) receiver, and the WAN includes a GPS network.

44. The software application of claim 43, wherein the second location information is based, at least in part on GPS signals received at the GPS receiver.

45. The software application of claim 33, wherein the at least one network includes an radio frequency identification (RFID) network having at least one RFID reader, and wherein the mobile device is an RFID device.

46. The software application of claim 45, wherein the second connection includes RFID signals transmitted from the RFID device and detected by at least one RFID reader, and wherein the second location information is determined based on a known location of the at least one RFID reader.

47. The computer system of claim 46, wherein the location synthesizer is configured to use the second location information to stabilize the first location information.
